(19) United States
(12) Patent Application Publication
(10) Pub. No.: US 2025/0071219 A1
(43) Pub. Date: Feb. 27, 2025

(54) IMAGE PROCESSING APPARATUS, CONTROL METHOD THEREFOR, AND STORAGE MEDIUM

(71) Applicant: CANON KABUSHIKI KAISHA, Tokyo (JP)

(72) Inventor: YOSHITAKA HATA, Tokyo (JP)

(21) Appl. No.: 18/811,090

(22) Filed: Aug. 21, 2024

(30) Foreign Application Priority Data
Aug. 24, 2023 (JP) 2023-136040

(51) Int. Cl. H04N 1/00

(52) U.S. Cl. CPC H04N 1/00477; H04N 1/00246; H04N 1/00278; H04N 2201/0094

(57) ABSTRACT

An image processing apparatus comprising a light emission control unit configured to control a mode of a light emitting unit configured to emit light, wherein the light emission control unit causes the light emitting unit to emit light in a color corresponding to a first mode when the image processing apparatus operates in the first mode upon receiving an instruction from a specific application.

### BACKGROUND

### Field

The present disclosure relates to an image processing apparatus, a control method therefor, and a storage medium.

### Description of the Related Art

In recent years, image processing apparatuses with light emitting units have become known. For example, Japanese Patent Application Laid-Open No. 2003-316287 discusses changing the backlight color of a display panel according to the state of a printing apparatus.

There are demands for further improvement in convenience of the image processing apparatuses each with a light emitting unit that varies in form according to the state of the image processing apparatus.

### SUMMARY

The present disclosure is directed to making it possible for users to easily recognize the state of an image processing apparatus.

According to an aspect of the present disclosure, an image processing apparatus comprising a light emission control unit configured to control a mode of a light emitting unit configured to emit light, wherein the light emission control unit causes the light emitting unit to emit light in a color corresponding to a first mode when the image processing apparatus operates in the first mode upon receiving an instruction from a specific application.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an image processing apparatus.

FIG. 2 is a diagram illustrating an operation unit of the image processing apparatus.

FIG. 3 is a diagram illustrating a hardware configuration of the image processing apparatus.

FIG. 4 is a flowchart illustrating processing of controlling light emission of a light emitting unit.

FIG. 5 is a flowchart illustrating processing of selecting an emission color of the light emitting unit.

FIG. 6 is a table illustrating emission colors of the light emitting unit.

FIG. 7 is a flowchart illustrating processing of setting a mode of the image processing apparatus.

FIG. 8 is a flowchart illustrating processing performed by a specific application.

FIG. 9 is a flowchart illustrating a process of selecting a brightness of the light emitting unit.

FIG. 10 is a flowchart illustrating a process of selecting a light emission mode of the light emitting unit.

FIG. 11 is a flowchart illustrating a process of selecting an emission color of a light emitting unit.

FIG. 12 is a table illustrating emission colors of the light emitting unit.

FIG. 13 is a flowchart illustrating a process of setting a mode of an image processing apparatus.

FIG. 14 is a flowchart illustrating processing performed by a specific application.

FIG. 15 is a diagram illustrating a setting screen for setting an emission color of the light emitting unit.

FIG. 16 is a diagram illustrating a setting screen for setting a brightness of the light emitting unit.

FIG. 17 is a diagram illustrating a print system including a cloud print service.

### DESCRIPTION OF THE EMBODIMENTS

The present disclosure will be described in detail below with reference to the drawings. Note exemplary embodiments described below are not intended to limit the claimed disclosure and not all combinations of features according to the exemplary embodiments are always essential to a solution of the present disclosure. Further, in the attached drawings, the same or similar components are assigned the same reference numeral, and redundant descriptions thereof are omitted.

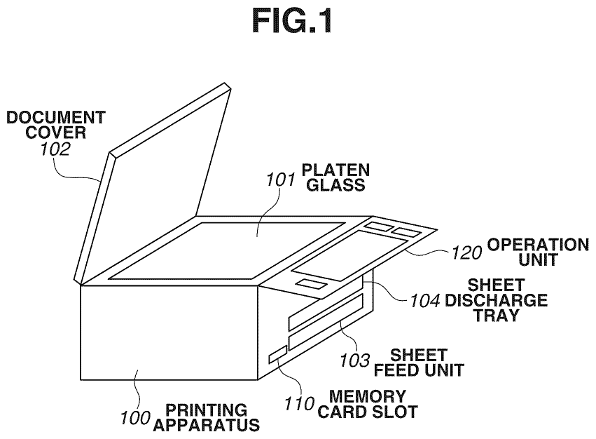

FIG. 1 is a diagram illustrating an external view of a printing apparatus 100, which is an example of an image processing apparatus. A multi-function printer (MFP) with a reading function (scanner) in addition to a printing function according to a first exemplary embodiment will be described below as an example. In FIG. 1, a platen glass 101 is a glass-like transparent platen used to place a document thereon and read the placed document with a scanner. A document cover 102 is a cover that prevents reading light from leaking to the outside during reading with the scanner.

A sheet feed unit 103 is an insertion slot where sheets of a plurality of sheet sizes can be set. The sheets set in the sheet feed unit 103 are conveyed one by one to a printing unit, undergo printing, and are discharged from a sheet discharge tray 104. A memory card slot 110 is a memory card insertion slot and is used to read image data from an inserted portable memory and execute printing.

An operation unit 120 is a unit via which a user inputs setting values and executes predetermined processes. The operation unit 120 is disposed on an outer surface of the printing apparatus 100. A printing method employed by the printing apparatus 100 in FIG. 1 may be an electrophotographic method, an inkjet method, or another method. Further, in a case where the inkjet method is employed, a configuration in which an ink cartridge is installed may be used, or a configuration in which ink is to be supplied to (injected into) a storage unit of the printing apparatus 100 may be used.

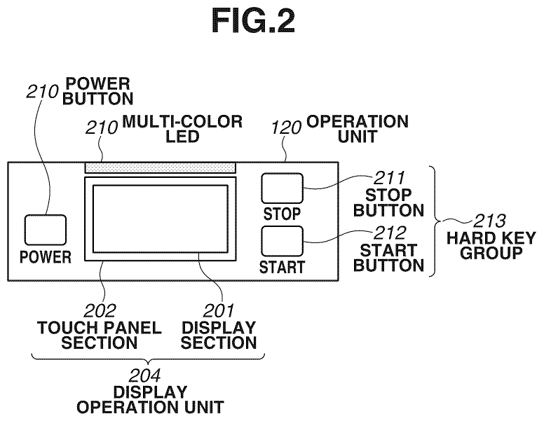

FIG. 2 is an enlarged front view illustrating the operation unit 120 of the printing apparatus 100 according to the first exemplary embodiment. As illustrated in FIG. 2, the operation unit 120 includes a display section 201, a touch panel section 202, a multi-color light emitting diode (multi-color LED) 203, and operation buttons 210 to 212 (a hard key group 213). The display section 201 is where a graphical user interface (GUI) is displayed. The GUI is operated via the touch panel section 202 (the display section 201 and the touch panel section 202 will be referred to as a display operation unit 204). The multi-color LED 203 indicates a state of the printing apparatus 100. The display section 201 is capable of displaying at least text and displays, for example, a status of the printing apparatus 100, setting values related to printing, and/or a preview of an image read from a memory card. The status of the printing apparatus 100 is, for example, ink level information that is information about ink, or information about a placed sheet (fed sheet). These pieces of information may be displayed with, for example, graphics or QR codes. The display section 201 is, for example, a display panel using a liquid crystal panel, but is not limited thereto. The touch panel section 202 is a unit on which operations can be performed with regard to information displayed in the display section 201, and the user can perform operations to input information about the printing apparatus 100. For example, the user can input setting values of print settings. The multi-color LED 203 is a light emitting unit configured to emit light and performs light emission control on one or more light emitting diodes (LEDs), which are light emitting members, based on the state of the printing apparatus 100. For example, the color, brightness, and light emission mode (mode) of light that the multi-color LED 203 emits are changed based on the state of the printing apparatus 100. Specifically, the multi-color LED 203 performs light emission control to emit light in a predetermined emission color, at a predetermined emission brightness, and in a predetermined light emission mode that correspond to a predetermined state of the printing apparatus 100. The multi-color LED 203 may be a light emitting unit including a plurality of light emitting members or a light emitting unit including a single light emitting member. With the multi-color LED 203, the user can recognize the state of the printing apparatus 100 even from a distance.

The power button 210, the stop button 211, and the start button 212 are disposed as operation buttons. At a press of the power button 210, the printing apparatus 100 is turned on or off. At a press of the start button 212, the printing apparatus 100 starts operating (copying, printing). At a press of the stop button 211, the printing apparatus 100 stops operating. The image processing apparatus according to the present exemplary embodiment does not have to include all the units of the printing apparatus 100 illustrated in FIGS. 1 and 2 and may include another unit or function.

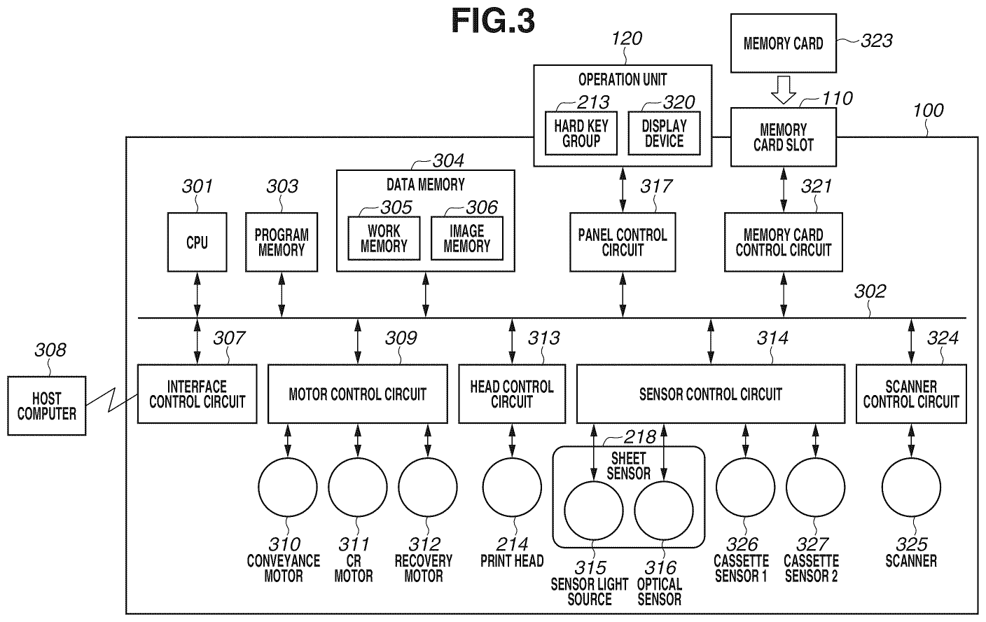

FIG. 3 is a block diagram illustrating a control system of the printing apparatus 100 according to the present exemplary embodiment. A central processing unit (CPU) 301 in the form of a micro-processor operates based on the content of a program memory 303 in the form of a read-only memory (ROM) and the content of a data memory 304 in the form of a random access memory (RAM). The program memory 303 and the data memory 304 are connected with the CPU 301 via an internal bus 302. The data memory 304 is used as a work memory 305 used by the CPU 301 to execute a control program and as an image memory 306 that stores image data to be formed on a recording sheet. The CPU 301 controls an interface control circuit 307, connects to a host computer 308 connected via an external interface, and communicates with the host computer 308.

For example, job data to be printed may be received from the host computer 308, which is an external apparatus, and the status of the printing apparatus 100 may be notified to the host computer 308. The host computer 308 is, for example, a personal computer (PC). However, this is not a limiting example, and various information processing apparatuses, such as a smartphone and a digital camera, may be employed as the host computer 308 according to the present exemplary embodiment. Further, the printing apparatus 100 may connect to a print server (not illustrated) or a cloud (external area) providing a cloud print service (hereinafter, CPS) and communicate with the CPS. The CPS is a specific application program.

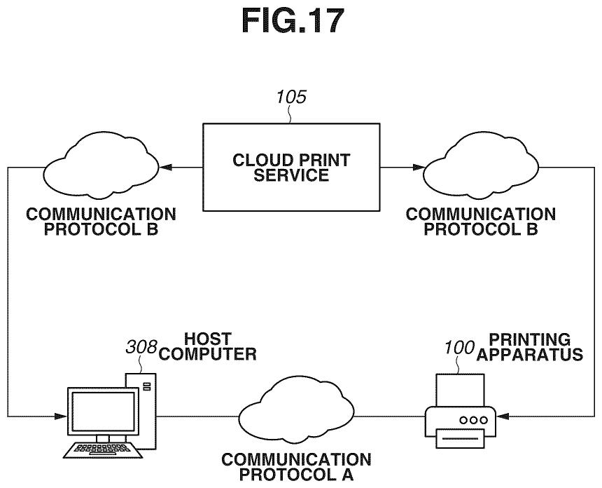

The CPS is a print system in which a printer driver (cloud printer driver) for the CPS is installed in the host computer 308. The host computer 308 generates a print job using the cloud printer driver and transmits the print job to the CPS. The CPS transmits the print job to the printing apparatus 100, and the printing apparatus 100 executes printing. FIG. 17 is a diagram illustrating a configuration of a print system using a CPS. A CPS 105 receives a print job from the host computer 308 and stores the print job. Further, in a case where a print job request is received from the printing apparatus 100, the CPS 105 transmits a print job to the printing apparatus 100. In a case where a print job is received from the CPS 105, the printing apparatus 100 executes printing. A communication protocol A is a protocol for performing communication between the host computer 308 and the printing apparatus 100. A communication protocol B is a protocol for performing network communication between the host computer 308 and the CPS 105 and between the printing apparatus 100 and the CPS 105. According to the present exemplary embodiment, the communication protocols A and B refer to upper-layer (application layer) protocols, and lower layer protocols may be protocols of the same type (e.g., Transmission Control Protocol/Internet Protocol (TCP/IP)). A communication method used to connect between the apparatuses may be, for example, a communication standard of the Institute of Electrical and Electronics Engineers (IEEE) 802.11 series (Wi-Fi) or short-range wireless communication, such as Near Field Communication (NFC) and Bluetooth® (such as Bluetooth® Classic or Bluetooth® Low Energy). Further, a QR Code® may be used in a case where the printing apparatus 100 issues a print job request to the CPS 105. In the print system according to the present exemplary embodiment, each apparatus may be directly connected, or the communication between apparatuses may be executed using Internet communication via a wireless local area network (wireless LAN) router. Further, each apparatus may communicate using mobile communication (e.g., third generation (3G), fourth generation (4G), fifth generation (5G)). While the print system according to the present exemplary embodiment is a system in which processes using the CPS are executed, the CPS may be configured to perform not only a printing process but also a scanning process and other processes, and the printing process is merely an example.

The CPU 301 controls various motors that drive mechanisms of the printing apparatus 100 via a motor control circuit 309. A conveyance motor 310 drives a sheet feed roller, a conveyance roller, and a sheet discharge roller and conveys recording sheets from the sheet feed unit 103 to the sheet discharge tray 104. A carriage motor 311 (CR motor in FIG. 3) drives a carriage in a reciprocating motion. Further, a recovery motor 312 drives a head recovery mechanism and performs a recovery operation to maintain a print head 214 in an appropriate state by controlling the head recovery mechanism in synchronization with the driving of the carriage. The CPU 301 controls the print head 214 via a head control circuit 313. By controlling the print head 214 in synchronization with the reciprocating motion of the carriage, an image is formed on a recording sheet. A cassette sensor 316 for the sheet feed unit 103 includes a photo interrupter and a mechanical switch. The cassette sensor 316 detects that the user has placed or removed a sheet on or from the sheet feed unit 103 of the printing apparatus 100, and the CPU 301 acquires information about the detection via a sensor control circuit 314. A display device 320 controls the operation unit 120 on the outer surface of the printing apparatus 100 via a panel control circuit 317. The display device 320 displays desired information on the display section 201, and receives a user operation via the touch panel section 202. Further, the display device 320 receives a user operation on the hard key group 213. Further, the display device 320 performs light emission control on the multi-color LED 203. Specifically, the display device 320 functions as a light emission control unit that performs light emission control so that the multi-color LED 203 emits light in an emission color, at a brightness, and in a light emission mode that correspond to the state of the printing apparatus 100. A scanner 325, which is not illustrated in FIG. 1, is controlled via a scanner control circuit 324, and a document image placed on the platen glass 101 of the scanner 325 is read. The CPU 301 reads and writes various files in a memory card 323 inserted into the memory card slot 110 disposed on the outer surface of the printing apparatus 100 via a memory card control circuit 321. An image read by the scanner 325 is first stored in the image memory 306 in the data memory 304 and then transmitted to the host computer 308 or stored as an image file in the memory card 323. Further, the scanner function can also be used as a copy function by controlling a printing mechanism and directly printing an image read by the scanner 325.

There may be a case where the printing process in the print system using the cloud, such as the CPS described above, is used to execute a printing process (secure printing process) of a print job that requires high security, e.g., a case where the printing process is used for business purposes. In such a case, it is necessary for the user and people around the printing apparatus 100 to be able to recognize that the secure printing process is being executed by the printing apparatus 100. Specifically, in a case where a printing process is executed by the printing apparatus 100 and a printed item is output, the printed item may be taken away by a third party other than the user. In this case, enabling the user and people around the printing apparatus 100 to recognize that the secure printing process is being executed by the printing apparatus 100 prevents the printed item from being taken away by a third party.

Thus, according to the present exemplary embodiment, in a case where the secure printing process is being executed by the printing apparatus 100, the printing apparatus 100 performs light emission control to indicate that the printing apparatus 100 is in a predetermined mode of executing the secure printing process. Specifically, in a case where the secure printing process is being executed by the printing apparatus 100, the light emission control unit transitions the mode of the light emitting unit to a mode that corresponds to the mode where the printing apparatus 100 executes the secure printing process. Further, in a case where no secure printing process is being executed by the printing apparatus 100, the light emission control unit transitions the mode of the light emitting unit to a mode that corresponds to a mode different from the mode where the printing apparatus 100 executes the secure printing process and is different from the mode that corresponds to the mode where the printing apparatus 100 executes the secure printing process. This enables the user and people around the printing apparatus 100 to recognize that the secure printing process is being executed by the printing apparatus 100, thereby preventing the printed item from being taken away by a third party.

The case where the printing apparatus 100 is executing the printing process that requires high security is not limited to the printing process in the print system using the cloud. An example may be a predetermined mode where the printing apparatus 100 is executing the printing process that requires high security. Hereinafter, a mode of the printing apparatus 100 where a printing process is executed in a print system using a specific application will be referred to as a work mode. In contrast, a mode where, instead of executing the printing process in the print system using the specific application, a printing process is executed by an application other than the specific application or a job (e.g., copying process, scanning process) is executed based on the setting values set via the display operation unit 204 of the printing apparatus 100 will be referred to as a normal mode. In the present exemplary embodiment, a form in which the emission color of the multi-color LED 203 of the printing apparatus 100 varies depending on whether the printing apparatus 100 is in a state of operating in the work mode or in a state of operating in the normal mode will be specifically described below.

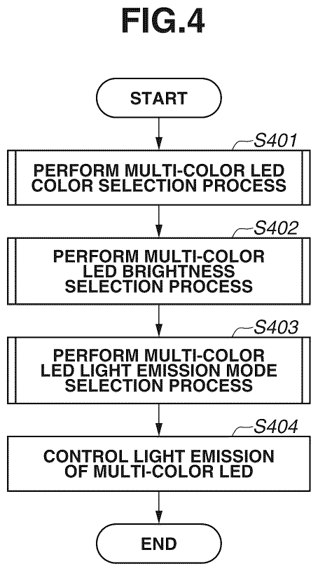

FIG. 4 is a flowchart illustrating processing of controlling light emission of the multi-color LED 203. Each time the state of the printing apparatus 100 changes, the flowchart is executed, so that the multi-color LED 203 indicates the state of the printing apparatus 100. The state of the printing apparatus 100 specifically includes a state where there is an error in the printing apparatus 100 and a state without an error (normal state). There are also a state where the printing apparatus 100 is in the normal state and in the work mode and a state where the printing apparatus 100 is in the normal state and in a mode other than the work mode.

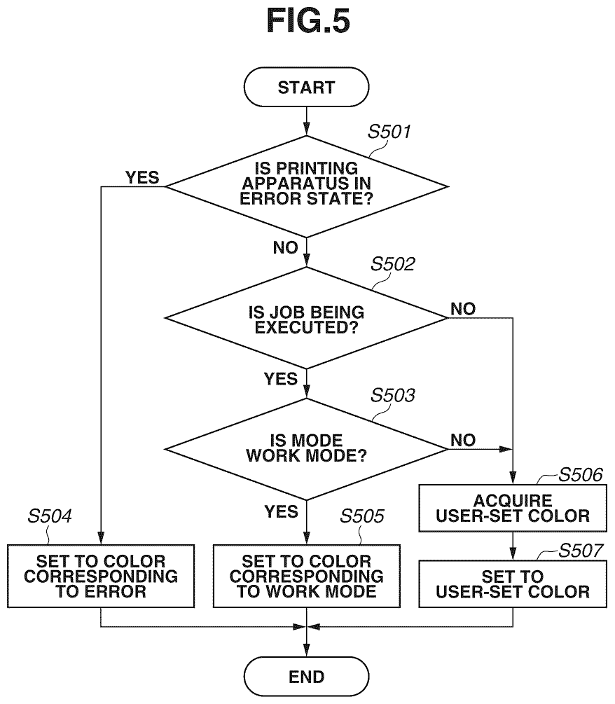

First, in step S401, the printing apparatus 100 selects the color of the multi-color LED 203. For example, the multi-color LED 203 is set to emit light in different colors depending on whether the printing apparatus 100 is in the error state or not in the error state, thereby indicating whether there is an error in the printing apparatus 100. Further, the multi-color LED 203 is set to emit light in different colors depending on whether the printing apparatus 100 is in the work mode or a mode (normal mode) other than the work mode, thereby indicating whether the printing apparatus 100 is in the work mode or a mode other than the work mode. The process of selecting the color of the multi-color LED 203 will be described in detail below with reference to FIG. 5.

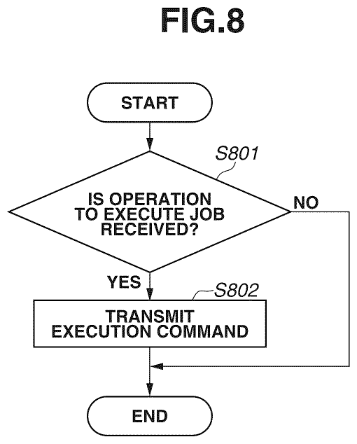

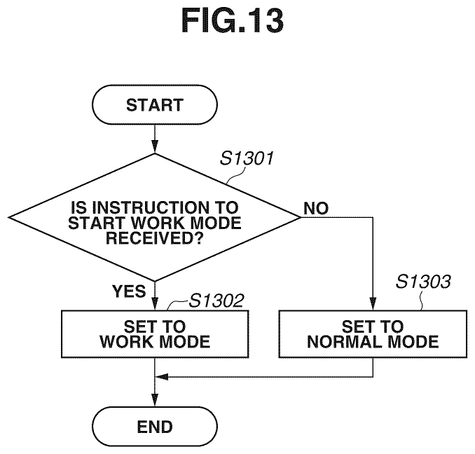

Next, in step S402, the printing apparatus 100 selects the brightness of the multi-color LED 203. For example, the multi-color LED 203 is set to emit light at different brightnesses depending on whether the printing apparatus 100 is in a power-saving state or not in the power-saving state, thereby indicating whether the printing apparatus 100 is in the power-saving state or not in the power-saving state. Specifically, in a case where the printing apparatus 100 is in the power-saving state, light is emitted at a brightness lower than that in a case where the printing apparatus 100 is not in the power-saving state. Instead of changing the brightness, red (R), green (G), and blue (B) (RGB) values of the color of the light emitting unit may be changed to express a change in brightness of the light emitting unit. A process of selecting the brightness of the multi-color LED 203 will be described in detail below with reference to FIG. 8. The brightness of the multi-color LED 203 can be set by the user. The user can set the multi-color LED 203 to a desired brightness within a range that can be set for the apparatus based on a usage environment of the user. The setting of the brightness of the multi-color LED 203 by the user will be described in detail below with reference to FIG. 13.

Next, in step S403, the printing apparatus 100 selects the light emission mode of the multi-color LED 203. For example, the multi-color LED 203 is configured to emit light in different light emission modes depending on whether a job is being executed or no job is being executed, thereby indicating whether the printing apparatus 100 is executing a job. Specifically, in a case where the printing apparatus 100 is in a state of not executing a job, the multi-color LED 203 is lighted. On the other hand, in a case where the printing apparatus 100 is in a state of executing a job, the multi-color LED 203 emits light in a light emission mode different from lighting, thereby explicitly indicating that the printing apparatus 100 is executing a job. In a case where there is an error in the printing apparatus 100, the multi-color LED 203 may emit light in a light emission mode different from lighting and from the light emission mode indicating that a job is being executed, thereby more explicitly indicating that there is an error in the printing apparatus 100.

While the form in which the multi-color LED 203 emits light in different light emission modes depending on whether the printing apparatus 100 is in the error state, in the state of executing a job, or in the state of not executing a job is described above as an example, the states of the printing apparatus 100 are not limited to those described above. For example, the states of the printing apparatus 100 may be a state where power is supplied (power is turned on), a state where power is disconnected (power is turned off), a state where an ink remaining amount decreases below a predetermined threshold, a state where a cover (not illustrated) of the printing apparatus 100 is opened to perform an operation to increase the ink remaining amount above the predetermined threshold, a state where an ink cartridge is removed, or the like. The multi-color LED 203 may be controlled to emit light in light emission modes corresponding to the foregoing states of the printing apparatus 100. Further, examples of the light emission modes include lighting, flashing, and blinking. At least two of the lighting, flashing, blinking, and turning off the light may be used in combination, and each of the two may be changed at an interval of corresponding predetermined time, thereby the light emission control is performed to emit light in a predetermined light emission mode suitable for the state of the printing apparatus 100.

While flashing and blinking are modes in which light is emitted in a predetermined color and a color different from the predetermined color alternately according to the present exemplary embodiment, a mode where the predetermined color and turning off the light are alternated may be employed. The brightness may be expressed by changing the RGB values of the color of the light emitting unit instead of changing a value indicating the brightness.

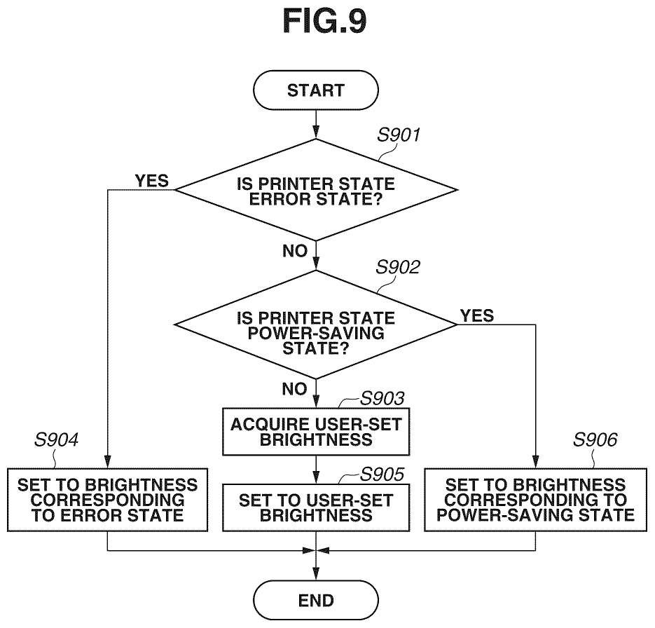

A process of selecting the light emission mode of the multi-color LED 203 will be described in detail below with reference to FIG. 9.

Next, in step S404, the printing apparatus 100 performs light emission control on the multi-color LED 203 based on the color, the brightness, and the light emission mode of the light emitting unit that are selected in steps S401 to S403, and the processing in the flowchart is ended.

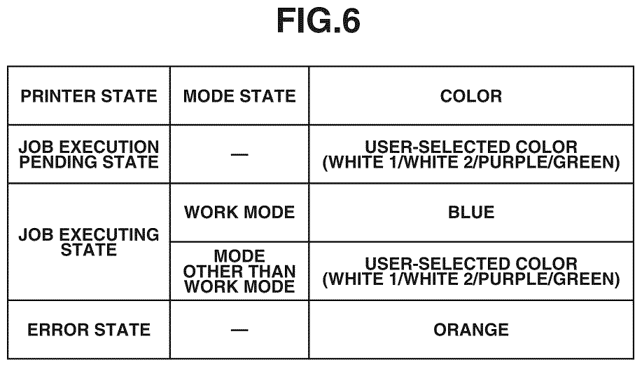

In step S404, in a case where the printing apparatus 100 is in the work mode, the printing apparatus 100 may perform display control on the display section 201 to indicate that the printing apparatus 100 is in the work mode. For example, text indicating the work mode may be displayed, and at least a portion in the display section 201, such as text information and frame information surrounding information displayed in the display section 201, is displayed in a color that indicates the work mode. For example, the at least the portion in the display section 201 is displayed in the same color as the light that the multi-color LED 203 emits in the case where the printing apparatus 100 is in the work mode, making it possible for the user to easily recognize that the printing apparatus 100 is in the work mode. For example, the display section 201 is displayed in blue indicating the work mode as described below with reference to FIG. 6.

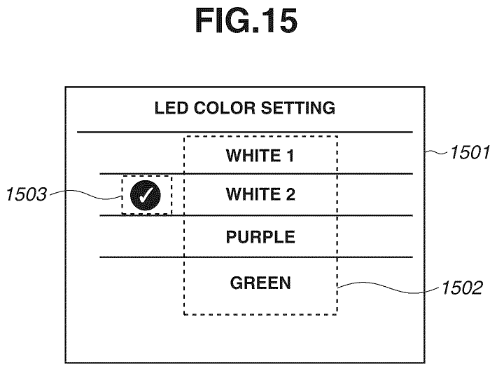

FIG. 5 is a flowchart illustrating the process of selecting the color of the multi-color LED 203 in step S401 in FIG. 4. FIG. 6 is a table illustrating emission colors of light that the multi-color LED 203 emits based on the state of the printing apparatus 100. The table indicates that the emission color of the multi-color LED 203, in a case where the state (printer state) of the printing apparatus 100 is a job execution pending state, is a color corresponding to a setting value set by the user on a setting screen for setting the emission color of the multi-color LED 203, which will be described below with reference to FIG. 15. Further, the table indicates that the emission color of the multi-color LED 203 is blue in a case where the printing apparatus 100 is in a job executing state and in the work mode. Further, the table indicates that the emission color of the multi-color LED 203 is the color corresponding to the setting value set by the user on the setting screen for setting the emission color of the multi-color LED 203, which will be described below with reference to FIG. 15, in a case where the printing apparatus 100 is in the job executing state and in a mode other than the work mode. The table further indicates that the emission color of the multi-color LED 203 is orange in a case where the printing apparatus 100 is in the error state. The colors corresponding to the different states of the printing apparatus 100 in FIG. 6 are predetermined colors that are not limiting, and are mere examples. Further, the emission color of the multi-color LED 203 that corresponds to the case where the printing apparatus 100 is in the error state is prioritized. Specifically, in a case where the printing apparatus 100 is in the job execution pending state, the job executing state, the work mode state, or the power-saving state and an error occurs, the multi-color LED 203 emits light in the emission color, at the brightness, and in the light emission mode that indicate the error state.

In step S501, the printing apparatus 100 determines whether the printing apparatus 100 is in the error state. In step S501, in a case where the printing apparatus 100 is determined to be in the error state (YES in step S501), the processing proceeds to step S504. In a case where the printing apparatus 100 is determined not to be in the error state (NO in step S501), the processing proceeds to step S502.

In step S504, the printing apparatus 100 selects the color corresponding to the error as the emission color of the multi-color LED 203. Orange corresponding to the case where the printer state is in the error state in FIG. 6 is selected as the color corresponding to the error.

In step S502, the printing apparatus 100 determines whether the printing apparatus 100 is executing a job. For example, whether a print job or a scan job is being executed is determined. In step S502, in a case where the printing apparatus 100 determines that a job is being executed (YES in step S502), the processing proceeds to step S503. In a case where the printing apparatus 100 determines that no job is being executed (NO in step S502), the processing proceeds to step S506. For example, a case where a determination result in step S502 is NO is the case where the printing apparatus 100 is in the job execution pending state, but any state that is a state other than the job executing state and is the error state may also be the case.

In step S503, the printing apparatus 100 acquires the mode of the printing apparatus 100 that is stored in the printing apparatus 100 and determines whether the printing apparatus 100 is in the work mode.

In step S505, the printing apparatus 100 selects the color corresponding to the work mode as the color for the multi-color LED 203 of the printing apparatus 100. Specifically, blue corresponding to the work mode of the mode state in FIG. 6 is selected.

In step S506, in a case where the printing apparatus 100 is in the normal mode, the printing apparatus 100 acquires information (setting value) indicating the emission color of the multi-color LED 203 from a memory of the printing apparatus 100.

The emission color of the multi-color LED 203 is set by receiving a user operation on the setting screen for setting the emission color of the multi-color LED 203, which is illustrated in FIG. 15. FIG. 15 is a diagram illustrating the setting screen for setting the emission color of the multi-color LED 203. Screen 1501 is a display screen that is displayed in the display section 201. The screen 1501 includes a color setting list 1502 from which the user can select a color and an icon 1503 indicating a value that is currently-set. By selecting a predetermined color from the color setting list 1502, the user can set the color of light that the multi-color LED 203 emits in a case where the printing apparatus 100 is in the normal mode. In a case where the predetermined color is selected on the screen 1501, the setting of the color of light that the multi-color LED 203 emits is confirmed, and the screen 1501 is closed. However, this is not a limiting configuration. For example, a confirm button for confirming the setting so that the multi-color LED 203 emits light in the selected predetermined color may further be displayed on the screen 1501, and a close button for closing the screen 1501 may further be displayed on the screen 1501. Further, the colors displayed in the color setting list 1502 are not limited to those described above, and information indicating other colors may be displayed.

By receiving the setting on the setting screen in FIG. 15, it becomes possible for the multi-color LED 203 to emit light in the emission color suitable for the usage environment of the user. In a case where no setting operation is received from the user on the setting screen illustrated in FIG. 15, a predetermined value (initial value) indicating a predetermined color is set to the emission color of the multi-color LED 203 in a case where the printing apparatus 100 is in the normal mode. For example, the initial value is “white 1”.

In step S507, the printing apparatus 100 determines the color corresponding to the acquired setting value to be the emission color of the multi-color LED 203, and the processing in the flowchart is ended.

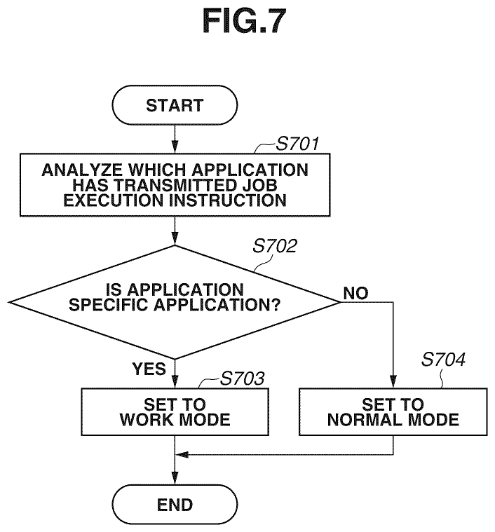

FIG. 7 is a flowchart illustrating a process of setting the work mode of the printing apparatus 100. The processing in the flowchart is started when a job execution instruction (command) that gives an instruction to execute a job, such as a printing execution instruction (or a scanning execution instruction), is received by the printing apparatus 100.

In step S701, the printing apparatus 100 analyzes which application has executed transmission of the job execution instruction and identifies the application having executed the transmission. For example, the printing apparatus 100 identifies the application having executed the transmission of the job execution instruction based on a parameter that is included in information indicating the job execution instruction (or transmitted together with the information indicating the job execution instruction) and indicates the type of application.

In step S702, the printing apparatus 100 determines whether the application having executed the transmission of the job execution instruction is a specific application. Specifically, whether the application is an application that supports the printing apparatus 100 operating in the work mode is determined. For example, whether the specific application is the above-described CPS is determined. In step S702, in a case where the printing apparatus 100 determines that the application is the specific application (YES in step S702), the processing proceeds to step S703. In a case where the printing apparatus 100 determines that the application is not the specific application (NO in step S702), the processing proceeds to step S704.

In step S703, the printing apparatus 100 sets the printing apparatus 100 to the work mode and transitions to the work mode. In a case where job execution based on the job execution instruction is completed, the printing apparatus 100 transitions from the work mode to the normal mode. Setting to the work mode is implemented, for example, by turning on a flag that indicates the work mode.

In step S704, the printing apparatus 100 sets the printing apparatus 100 to the normal mode and transitions to the normal mode. Setting to the normal mode is implemented, for example, by turning on a flag that indicates the normal mode.

FIG. 8 is a flowchart illustrating processing performed by the specific application on the host computer 308. The processing in the flowchart is started when the specific application is activated.

In step S801, the specific application determines whether an operation to start job execution is received from the user. The operation to start the job execution refers to, for example, a printing execution operation or a scanning execution operation. In step S801, in a case where the specific application determines that the operation to start the job execution is received (YES in step S801), the processing proceeds to step S802. In a case where the specific application determines that no operation to start the job execution is received (NO in step S801), the processing in the flowchart is ended.

In step S802, the specific application transmits a job execution instruction (command) to the printing apparatus 100. For example, a printing instruction or a scanning execution instruction is transmitted to the printing apparatus 100. Then, the processing in the flowchart is ended.

FIG. 9 is a flowchart illustrating the process of selecting the brightness of the multi-color LED 203 in step S402 in FIG. 4.

In step S901, the printing apparatus 100 determines whether the printing apparatus 100 is in the error state. In a case where the printing apparatus 100 determines that the printing apparatus 100 is in the error state (YES in step S901), the processing proceeds to step S904. In a case where the printing apparatus 100 determines that the printing apparatus 100 is not in the error state (NO in step S901), the processing proceeds to step S902.

In step S904, the printing apparatus 100 sets the brightness of the light emission of the multi-color LED 203 to a brightness corresponding to the error state, and the processing in the flowchart is ended. For example, a brightness higher than brightnesses corresponding to states other than the error state is set. This makes it possible for the user to recognize the error state more easily and to resolve the error state promptly.

In step S902, the printing apparatus 100 determines whether the printing apparatus 100 is in the power-saving state. In a case where the result of the determination in step S902 is YES (YES in step S902), the processing proceeds to step S906. In a case where the result of the determination in step S902 is NO (NO in step S902), the processing proceeds to step S903.

In step S906, the printing apparatus 100 sets the brightness of the light emission of the multi-color LED 203 to a brightness corresponding to the power-saving state, and the processing in the flowchart is ended.

In step S903, the printing apparatus 100 acquires information (setting value) indicating the brightness of the light emission of the multi-color LED 203 from the memory of the printing apparatus 100.

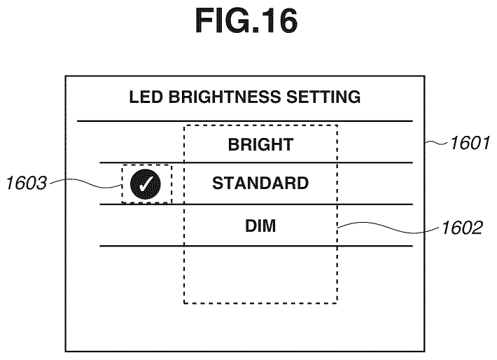

The brightness of the light emission of the multi-color LED 203 is set by receiving a user operation on a setting screen for setting the brightness of the light emission of the multi-color LED 203, which is illustrated in FIG. 16. FIG. 16 is a diagram illustrating the setting screen for setting the brightness of the light emission of the multi-color LED 203. A screen 1601 is displayed in the display section 201. The screen 1601 includes a brightness setting list 1602 from which the user can select a brightness and an icon 1603 indicating a value that is currently-set. By selecting a predetermined brightness from the brightness setting list 1602, the user can set the brightness of light that the multi-color LED 203 emits in a case where the printing apparatus 100 is not in the error state and not in the power-saving state. In a case where the predetermined brightness is selected on the screen 1601, the setting of the brightness of light that the multi-color LED 203 emits is confirmed, and the screen 1601 is closed. However, this is not a limiting configuration. For example, a confirm button for confirming the setting so that the multi-color LED 203 emits light at the selected predetermined brightness may further be displayed on the screen 1601, and a close button for closing the screen 1601 may further be displayed on the screen 1601. Further, the brightnesses displayed in the brightness setting list 1602 are not limited to those described above, and information indicating other brightnesses may be displayed.

By receiving the setting on the setting screen in FIG. 16, it becomes possible for the multi-color LED 203 to emit light at the brightness suitable for the usage environment of the user. In a case where no setting operation is received from the user on the setting screen illustrated in FIG. 16, a predetermined value (initial value) indicating a predetermined brightness is set to the brightness of the light emission of the multi-color LED 203 in a case where the printing apparatus 100 is not in the error state and not in the power-saving state. For example, the initial value is “white 1”.

In step S905, the printing apparatus 100 determines the brightness corresponding to the acquired setting value to be the brightness of the light emission of the multi-color LED 203, and the processing in the flowchart is ended.

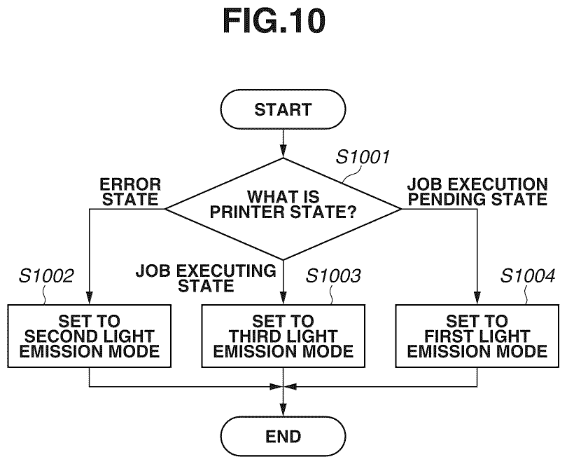

FIG. 10 is a flowchart illustrating a process of selecting the light emission mode of the multi-color LED 203 in step S403 in FIG. 4.

In step S1001, the printing apparatus 100 determines which state the printing apparatus 100 is in. In a case where the printing apparatus 100 is determined to be in the error state (ERROR STATE in step S1001), the processing proceeds to step S1002. In a case where the printing apparatus 100 is determined to be in the job executing state (JOB EXECUTING STATE in step S1001), the processing proceeds to step S1003. In a case where the printing apparatus 100 is determined to be in the job-execution-pending state (JOB EXECUTION PENDING STATE in step S1001), the processing proceeds to step S1004.

In step S1004, the printing apparatus 100 sets the light emission mode of the multi-color LED 203 to a first light emission mode, and the processing in the flowchart is ended. The first light emission mode is, for example, lighting. The first light emission mode is not limited to lighting and may be, for example, turning off the light.

In step S1002, the printing apparatus 100 sets the light emission mode of the multi-color LED 203 to a second light emission mode different from the first light emission mode, and the processing in the flowchart is ended. The second light emission mode is, for example, flashing. The flashing is expressed by alternately lighting a first color of the multi-color LED 203 and a second color different from the first color. Alternatively, the flashing is expressed by repeatedly turning on and off the first color of the multi-color LED 203. The first color is the color selected in step S401 in FIG. 4.

In step S1003, the printing apparatus 100 sets the light emission mode of the multi-color LED 203 to a third light emission mode different from the first and second light emission modes, and the processing in the flowchart is ended. The third light emission mode is, for example, a mode where the brightness changes in stages based on a first brightness. The first brightness may be the highest brightness, the brightness corresponding to the median value of the stages, or the lowest brightness. The third light emission mode is expressed by repeatedly turning on the light at the first brightness, at a second brightness lower than the first brightness, and at the Nth brightness. The first brightness is the brightness selected in step S402 in FIG. 4.

The first to third light emission modes are not limited to those described above and, for example, may be settable by the user so that the multi-color LED 203 emits light in the set mode.

In step S404 in FIG. 4, the printing apparatus 100 performs light emission control on the multi-color LED 203 in the color, at the brightness, and in the light emission mode of the light emitting unit that are selected in steps S401 to S403. For example, in a case where the printing apparatus 100 is in the error state, the multi-color LED 203 emits light in a mode where orange light and white light are alternately lighted (flashed) at a higher brightness compared to the states other than the error state. Further, for example, in a case where the printing apparatus 100 is in the job executing state and in the work mode, the multi-color LED 203 emits light in a mode where the color of the light is blue, which corresponds to the work mode, and the brightness of the light changes in stages based on the user-set brightness. Further, for example, in a case where the printing apparatus 100 is in the job executing state and not in the work mode, the multi-color LED 203 emits light in a mode where the color of the light is the user-set color and the brightness of the light changes in stages based on the user-set brightness.

Specifically, in a case where the printing apparatus 100 is in a first state, the multi-color LED 203 is lighted, and in a case where the printing apparatus 100 transitions from the first state to a second state, the multi-color LED 203 emits light in a mode where the light alternates between a predetermined color and another color different from the predetermined color, or in a mode where the predetermined color and turning off the light are alternated. Further, in the case where the printing apparatus 100 is in the first state, the multi-color LED 203 is turned off, and in a case where the printing apparatus 100 transitions from the first state to the second state, the multi-color LED 203 emits light in a mode where the light alternates between a predetermined color and another color different from the predetermined color, or in a mode where the predetermined color and turning off the light are alternated.

According to the exemplary embodiment described above, in a case where the secure printing process is being executed by the printing apparatus 100, the printing apparatus 100 performs the light emission control on the light emitting unit to indicate that the printing apparatus 100 is in the predetermined mode where the printing apparatus 100 executes the secure printing process. Specifically, in the case where the secure printing process is being executed by the printing apparatus 100, the light emission control unit transitions the mode of the light emitting unit to the mode that corresponds to the mode where the printing apparatus 100 executes the secure printing process. Further, in a case where no secure printing process is being executed by the printing apparatus 100, the light emission control unit transitions the mode of the light emitting unit to a mode that corresponds to a mode (normal mode) different from the mode where the printing apparatus 100 executes the secure printing process and is different from a mode that corresponds to the mode where the printing apparatus 100 executes the secure printing process. This enables the user and people around the printing apparatus 100 to recognize that the secure printing process is being executed by the printing apparatus 100, thereby preventing the printed item from being taken away by a third party.

In the first exemplary embodiment described above, the form has been described where, in a case where the job execution instruction is received from the specific application, the printing apparatus 100 transitions to the work mode, and in a case where the job execution is completed, the printing apparatus 100 transitions (returns) from the work mode to the normal mode.

In a second exemplary embodiment, a form is described where, in a case where an instruction to start the work mode is received from the specific application, the printing apparatus 100 transitions to the work mode, and in a case where an instruction to end the work mode is received, the printing apparatus 100 transitions (returns) to the normal mode. Specifically, the emission color of the multi-color LED 203 is selected based on whether the printing apparatus 100 is in the work mode regardless of whether the printing apparatus 100 is in the job executing state. Only a difference between the present exemplary embodiment and the first exemplary embodiment will be described below.

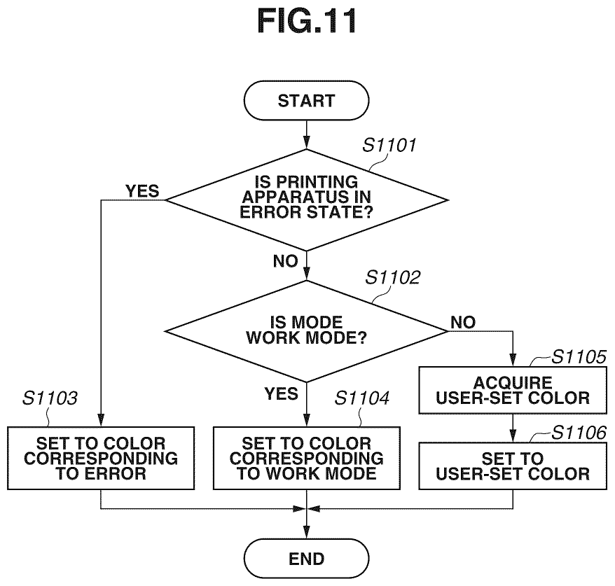

FIG. 11 is a flowchart illustrating the process of selecting the color of the multi-color LED 203 in step S401 in FIG. 4. In this flowchart, the process of determining whether the printing apparatus 100 is in the job executing state, which corresponds to step S502 in FIG. 5, is not executed.

Step S1101 is similar to step S501 in FIG. 5, and thus a redundant description thereof is omitted. The state that is determined not to be the error state in step S401 is, for example, the job executing state or the job execution pending state, but may be another state.

Steps S1102 to S1106 are similar to steps S503 to S507 in FIG. 5, and thus redundant descriptions thereof are omitted.

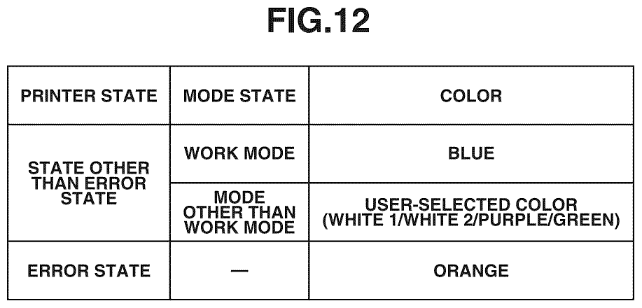

FIG. 12 is a table illustrating emission colors of light that the multi-color LED 203 emits based on the state of the printing apparatus 100. The table indicates that the emission color of the multi-color LED 203 is blue in a case where the state (printer state) of the printing apparatus 100 is a state other than the error state and the printing apparatus 100 is in the work mode. Further, the table indicates that the emission color of the multi-color LED 203, in a case where the printing apparatus 100 is in a state other than the error state and not in the work mode, is the color corresponding to the setting value set by the user on the setting screen for setting the emission color of the multi-color LED 203, which is described above with reference to FIG. 15. Further, the table indicates that the emission color of the multi-color LED 203 is orange in a case where the printing apparatus 100 is in the error state. The colors corresponding to the different states of the printing apparatus 100 in FIG. 12 are mere examples and not limiting colors. The state other than the error state is, for example, the job executing state or the job execution pending state, but may be another state.

FIG. 13 is a flowchart illustrating a process of setting the work mode of the printing apparatus 100. The processing in the flowchart is started when a predetermined instruction from the specific application on the host computer 308 is received by the printing apparatus 100. The predetermined instruction is an instruction (command) to start the work mode of the printing apparatus 100 or an instruction to end the work mode. Specifically, the flowchart is a flowchart for transitioning the printing apparatus 100 to the work mode even in a standby state before job execution. The printing apparatus 100 operates in the normal mode in a case where neither a work mode start command nor a work mode end command is received.

In step S1301, the printing apparatus 100 determines whether the instruction received from the specific application is an instruction to start the work mode. In a case where it is determined that an instruction to start the work mode is received (YES in step S1301), the processing proceeds to step S1302. In a case where it is determined that an instruction to end the work mode is received (NO in step S1301), the processing proceeds to step S1303.

In step S1302, the printing apparatus 100 sets the printing apparatus 100 to the work mode, and the processing in the flowchart is ended.

In step S1303, the printing apparatus 100 sets the printing apparatus 100 to the normal mode, and the processing in the flowchart is ended.

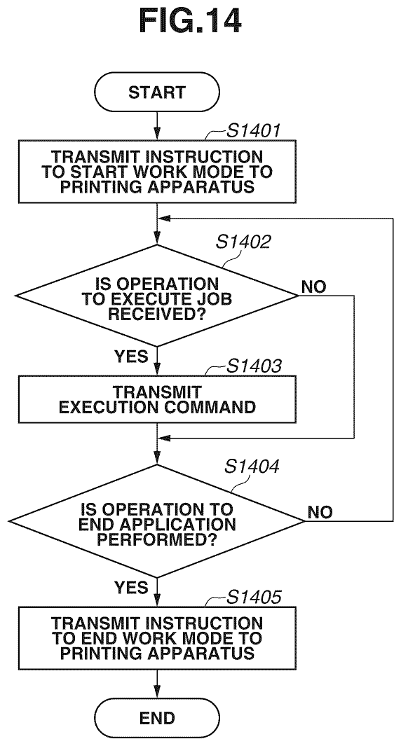

FIG. 14 is a flowchart illustrating processing performed by the specific application on the host computer 308.

In step S1401, the specific application transmits an instruction to start the work mode to the printing apparatus 100.

Steps S1402 and S1403 are similar to steps S801 and S802 in FIG. 8, and thus redundant descriptions thereof are omitted. In a case where the execution command transmitted in step S1403 is received, the printing apparatus 100 executes the job.

In step S1404, the specific application determines whether an operation to end the specific application is performed. In step S1404, in a case where it is determined that an operation to end the specific application is executed (YES in step S1404), the processing proceeds to step S1405. In a case where it is determined that an operation to end the specific application is not executed (NO in step S1404), the processing returns to step S1402.

In step S1405, the specific application transmits an instruction to end the work mode to the printing apparatus 100, and the processing in the flowchart is ended.

In the exemplary embodiment described above, the form has been described where, in a case where the instruction to start the work mode is received from the specific application, the printing apparatus 100 transitions to the work mode, and in a case where the instruction to end the work mode is received, the printing apparatus 100 transitions (returns) to the normal mode. Thus, even in a state where the printing apparatus 100 is not executing a job, the printing apparatus 100 is transitioned to the work mode, and the multi-color LED 203 emits light in the color corresponding to the work mode. This enables the user and people around the printing apparatus 100 to recognize that the printing apparatus 100 is in the work mode even in a state where the printing apparatus 100 is not executing a job, thereby preventing the printed item from being taken away by a third party.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-136040, filed Aug. 24, 2023, which is hereby incorporated by reference herein in its entirety.

What is claimed is:

1. An image processing apparatus comprising:
a light emission control unit configured to control a mode of a light emitting unit configured to emit light,
wherein the light emission control unit causes the light emitting unit to emit light in a color corresponding to a first mode when the image processing apparatus operates in the first mode upon receiving an instruction from a specific application.

2. The image processing apparatus according to claim 1, wherein the light emission control unit causes the light emitting unit to emit light in a color different from the color corresponding to the first mode when the image processing apparatus is not operating in the first mode.

3. The image processing apparatus according to claim 1, wherein the color of the light that the light emitting unit emits when the image processing apparatus is not operating in the first mode is a color set by a user that is selected from among colors different from the color corresponding to the first mode.

4. The image processing apparatus according to claim 1, wherein the specific application is an application configured to cause the image processing apparatus to execute a job stored in an external area of the image processing apparatus.

5. The image processing apparatus according to claim 4, wherein the instruction received from the specific application by the image processing apparatus is a job execution instruction to cause the image processing apparatus to execute the job.

6. The image processing apparatus according to claim 5, further comprising an execution unit configured to execute the job,
wherein the execution unit executes the job in a case where the job execution instruction is received.

7. The image processing apparatus according to claim 5, wherein the image processing apparatus ends operating in the first mode when execution of the job is completed.

8. The image processing apparatus according to claim 1, wherein the instruction received from the specific application by the image processing apparatus is an instruction to start operating in the first mode.

9. The image processing apparatus according to claim 1, wherein the image processing apparatus ends operating in the first mode when the image processing apparatus receives an instruction to end operating in the first mode from the specific application.

10. The image processing apparatus according to claim 1, further comprising a display section being different from the light emitting unit and configured to display at least text.

11. A method for controlling an image processing apparatus, the method comprising performing light emission control to control a mode of a light emitting unit configured to emit light,
wherein, in a case where the image processing apparatus operates in a first mode by receiving an instruction from a specific application, the light emitting unit is caused to emit light in a color corresponding to the first mode.

12. A non-transitory computer-readable storage medium storing computer executable instructions that, when executed by one or more processors of an image processing apparatus, perform light emission control to control a mode of a light emitting unit configured to emit light by causing the light emitting unit to emit light in a color corresponding to a first mode when the image processing apparatus operates in the first mode upon receiving an instruction from a specific application.
